(19) United States
(12) Patent Application Publication
(10) Pub. No.: US 2006/0272576 A1
(43) Pub. Date: Dec. 7, 2006

(54) Piping system structure of semiconductor equipment

(76) Inventors: Chain-Chi Huang, Hsinchu (TW); Tsung-Han Peng, Hsinchu (TW); Ching-Hui Wang, Hsinchu (TW); Sue-Peng Wang, Hsinchu (TW)

Correspondence Address: J C PATENTS, INC., 4 VENTURE, SUITE 250, IRVINE, CA, 92618, US

(21) Appl. No.: 11/144,228

(22) Filed: Jun. 2, 2005

(51) Int. Cl. B05C 11/00

(52) U.S. Cl. 118/683; 118/300; 118/692

(57) ABSTRACT

A piping system structure of semiconductor equipment comprises a vessel, a nozzle and a pneumatic pump. The pneumatic pump drains a fluid material in the vessel and transmits the fluid material to the nozzle to spray on the wafer. The piping system structure further comprises a first sensor, a second sensor and a processor. Wherein, the first sensor and the second sensor are disposed at the pneumatic pump to sense whether a valve in the pneumatic pump is at a first position or at a second position and generate a first sensing signal and a second sensing signal to the processor, respectively. When the difference between the time of receiving the first sensing signal and the time of receiving the second sensing signal exceeds a preset value, the processor determines that the operation of the pump is abnormal. Then, the processor controls the semiconductor equipment to generate a warning message.

### BACKGROUND OF THE INVENTION

1. Field of the Invention

The present invention relates to a piping system structure, and more particularly, to a piping system structure of semiconductor equipment.

2. Description of the Related Art

Various liquids are used in different processes in semiconductor fabrication. For example, a photoresist (PR) is used in a coating process in which the photoresist is sprayed on the wafer for a subsequent lithographic process.

FIG. 1 is a schematic drawing showing a prior art piping system structure of a photoresist coater. The photoresist coater is adapted for a photoresist coating process to uniformly spray the photoresist on the wafer. Referring to FIG. 1, the prior art piping system structure of the photoresist coater comprises the photoresist tank 101, the buffer tank 103, the nozzle 105 and the electrical pump 110. Wherein, the electrical pump 110, such as a CYBOR pump, pumps the photoresist stored in the photoresist tank 101 to the nozzle 105 through the buffer tank 103. The nozzle 105 sprays the photoresist on the wafer during the photoresist coating process.

Generally, the electrical pump 110, such as CYBOR pump, comprises the stepping motor 112 and the magnetic valve 114. Wherein, the stepping motor 112 drains and transmits the photoresist stored in the photoresist tank 101 to the magnetic valve 114 through the buffer tank 103. The magnetic valve 114 controls the flow of the photoresist and transmits the photoresist to the nozzle 105 during the photoresist coating process.

Accordingly, the prior art piping system structure of the photoresist coater has the following disadvantages:

1. Since the operation of the stepping motor in the electrical pump is slow, it affects the operating efficiency of the photoresist coater. As a result, the throughput of the photoresist coating process is reduced.

2. Due to the large size of an electrical pump, the photoresist coater occupies a lot of space as well.

### SUMMARY OF THE INVENTION

Accordingly, the present invention is directed to a piping system structure of semiconductor equipment. The piping system structure enhances the throughput of the semiconductor process.

The present invention is directed to a piping system structure of semiconductor equipment. The piping system structure reduces the size of the semiconductor equipment.

The present invention is also directed to a piping system structure of semiconductor equipment. The piping system structure monitors whether the operation of the semiconductor equipment is normal.

The present invention provides a piping system structure of semiconductor equipment. The semiconductor equipment is adapted to dispense a fluid material over a wafer. The piping system structure of the present invention comprises a vessel, a nozzle and a pneumatic pump. Wherein, the pneumatic pump pumps the fluid material from the vessel to the nozzle to spray the fluid material over the wafer. In addition, the piping system structure of the present invention further comprises a control module which controls an operation of the pneumatic pump and monitors whether the operation is normal.

According to an embodiment of the present invention, the semiconductor equipment described above is a photoresist coater. The vessel comprises a photoresist tank. The fluid material comprises a photoresist. In addition, the piping system structure of the present invention further comprises a buffer tank disposed between the vessel and the pneumatic pump to remove bubbles in the photoresist.

In addition, the control module described above comprises the liquid adjusting valve and the gas adjusting valve, which are coupled to the pneumatic pump. The control module comprises a flow control unit, a magnetic valve and a pressure control unit. Wherein, the flow control unit controls the pneumatic pump through the liquid adjusting valve to determine a time of stopping spraying the fluid material. The magnetic valve is coupled to the liquid adjusting valve and the gas adjusting valve. The pressure control unit drives the pneumatic pump through the magnetic valve.

In some embodiments, the pneumatic pump described above is an IWAKI pump.

Additionally, the present invention provides a piping system structure of semiconductor equipment. The piping system structure comprises a vessel, a nozzle and a pump. Wherein, the pump pumps the fluid material from the vessel to the nozzle to spray the fluid material over the wafer. In addition, the piping system of the present invention comprises a first sensor, a second sensor and a processor. Wherein, the first sensor and the second sensor are disposed at the pump to sense a first position and a second position of a valve in the pump and output a first sensing signal and a second sensing signal, respectively. When a difference between a time of receiving the first sensing signal and a time of receiving the second sensing signal is larger than a preset value, the processor determines that an operation of the pump is abnormal and controls the semiconductor equipment to generate a warning message.

Accordingly, the pneumatic pump of the present invention can effectively reduce the size of the semiconductor equipment. The process throughput is also increased. Since the sensors at the pump of the present invention sense the position of the valve of the pump, whether the operation of the pump is normal can be determined according to the position of the valve of the pump. If the operation of the pump is abnormal, a warning message is generated and outputted to inform operators.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a schematic drawing showing a prior art piping system structure of a photoresist coater.

FIG. 2 is a schematic drawing showing a piping system structure of semiconductor equipment according to a preferred embodiment of the present invention.

FIG. 3 is a circuit of a monitor unit according to a preferred embodiment of the present invention.

### DESCRIPTION OF SOME EMBODIMENTS

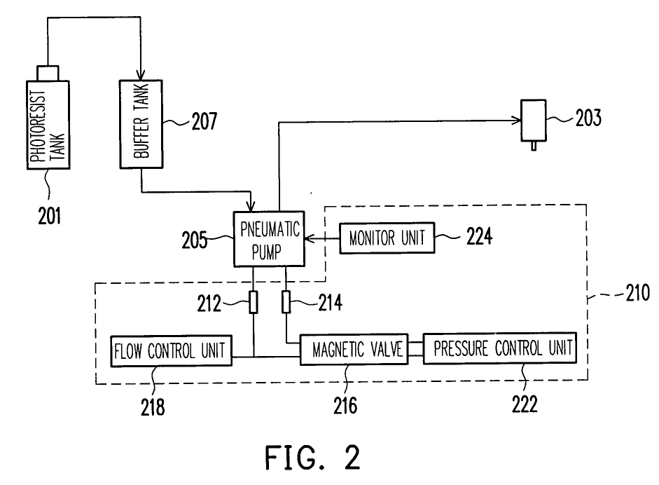

FIG. 2 is a schematic drawing showing a piping system structure of semiconductor equipment according to a preferred embodiment of the present invention. Referring to FIG. 2, the semiconductor equipment is adapted to dispense a fluid material stored in the vessel 201 on a wafer (not shown) through the nozzle 203. The dispensing process can be performed by pumping the fluid material stored in the vessel 201 to the nozzle 203 through the pneumatic pump 205.

In this embodiment, the semiconductor equipment described above can be a photoresist coater. The vessel 201 can be a photoresist tank. The fluid material can be photoresist. To simplify the interpretation and let one of ordinary skill in the art understand the present invention, a photoresist coater is used as the exemplary embodiment of the present invention. One of ordinary skill in the art knows that the scope of the present invention is not limited to the photoresist coater.

When a photoresist coating process is to be performed to a wafer, the wafer is transferred to and beneath the nozzle 203. The control module 210 triggers the pneumatic pump 205 which drain the photoresist stored in the photoresist tank 201 through the buffer tank 207. The photoresist is then transmitted to the nozzle 203 to be sprayed over the wafer. Wherein, the buffer tank 207 removes bubbles in the photoresist to prevent the thickness non-uniformity of the photoresist on the wafer. The wafer sprayed with photoresist then is spun with a high speed so that the photoresist is uniformly sprayed on the surface of the wafer. The photoresist coating process thus is completed. In some embodiments, the pneumatic pump 205 is an IWAKI pump.

Generally, the control module 210 comprises the liquid adjusting valve 212, the gas adjusting valve 214, the magnetic valve 216, the flow control unit 218 and the pressure control unit 222. Wherein, the liquid adjusting valve 212 is controlled by the flow control unit 218. The liquid adjusting valve 212 and the gas adjusting valve 214 are coupled to the pneumatic pump 205. The flow control unit 218 controls the pneumatic pump 205 through the liquid adjusting valve 212 so as to control the amount of the photoresist sprayed by the nozzle 203. When the amount of the photoresist sprayed by the photoresist coater reaches a preset condition, the flow control unit 218 controls the pneumatic pump 205 through the liquid adjusting valve 212 so as to stop supplying the photoresist to the nozzle 203.

In addition, the pressure control unit 222 is coupled to the liquid adjusting valve 212 and the gas adjusting valve 214 through the magnetic valve 216. The pressure control unit 222 controls the operation of the pneumatic pump 205 through the liquid adjusting valve 212 and the gas adjusting valve 214.

Note that the control module 210 of the present invention further comprises the monitor unit 224 to monitor whether the operation of the pneumatic pump 205 is normal. If the operation of the pneumatic pump is abnormal, the monitor unit 224 generates a warning message to operators.

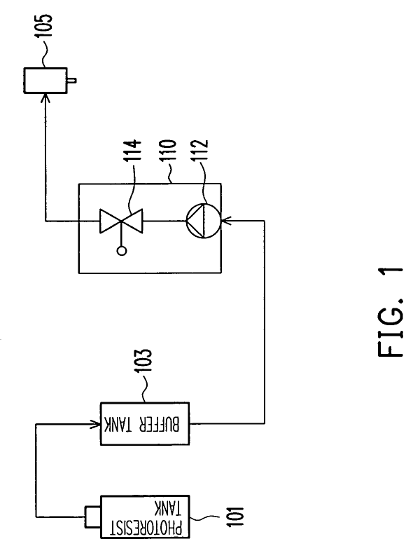

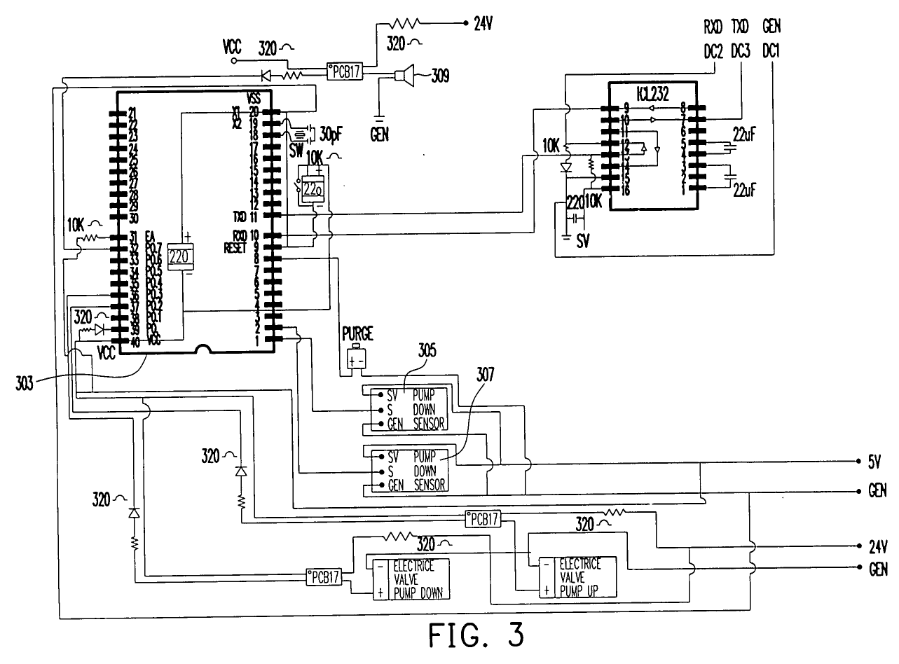

FIG. 3 is a circuit of a monitor unit according to a preferred embodiment of the present invention. Referring to FIG. 3, the monitor unit comprises the driving chip 301 and the processor, such as a programmable chip 303. In this embodiment, the programmable chip 303 can be an 8051 chip. Wherein, the driving chip 301 triggers the monitor unit, and the programmable 303 is coupled to the sensors 305 and 307. Wherein, the sensor 305 senses if the valve in the pump of FIGS. 1 and 2 is at the first position, such as the lowest position. The sensor 307 senses if the valve in the pump is at the second position, such as the highest position.

When the sensor 305 senses that the valve in the pump is at the first position, a first sensing signal is generated and transmitted to the programmable chip 303. Similarly, when the sensor 307 senses that the valve in the pump is at the second position, a second sensing signal is generated and transmitted to the programmable chip 303. Wherein, the programmable chip 303 comprises a timing program. When the programmable chip 303 receives one of the first and second sensing signals, the timing program is triggered to count the time of receiving another of the first and second sensing signals. By the programmable chip 303, if the difference between the time of receiving the first sensing signal and the time of receiving the second sensing signal is larger than a preset value, it means that the operation of the pump is abnormal. The programmable chip 303 then generates the warning message to operators for maintenance.

In this embodiment, the programmable chip 303 may be coupled to a buzzer 309. If the programmable chip 303 determines that the operation of the pump is abnormal, the buzzer generates a warning sound to the operators for maintenance.

Accordingly, the present invention comprises at least the following advantages:

1. The piping system structure of the present invention comprises a pneumatic pump. Due to the high speed operation of the pneumatic pump, the throughput of the semiconductor process by semiconductor equipment, such as a photoresist coater, is effectively enhanced.

2. The size of the semiconductor equipment of the present invention is also effectively reduced because of the small size of the pneumatic pump. Further, the costs of the semiconductor equipment are lowered.

3. According to the present invention, a monitor unit is added to monitor whether the operation of the pump of the piping system structure is normal. If the operation of the pump is abnormal, the piping system structure generates a warning message to operator for maintenance. Accordingly, the yield of the semiconductor process will not be affected.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A piping system structure of semiconductor equipment, wherein the semiconductor equipment is adapted to dispense a fluid material over a wafer, the piping system structure comprising:
a vessel, accommodating the fluid material;
a nozzle, spraying the fluid material over the wafer;
a pneumatic pump, pumping the fluid material from the vessel to the nozzle to spray the fluid material over the wafer; and
a control module, controlling an operation of the pneumatic pump and monitoring whether the operation is normal.

2. The piping system structure of semiconductor equipment of claim 1, wherein the semiconductor equipment is a photoresist coater.

3. The piping system structure of semiconductor equipment of claim 2, wherein the vessel comprises a photoresist tank.

4. The piping system structure of semiconductor equipment of claim 2, further comprising a buffer tank, which is disposed between the photoresist tank and the pneumatic pump, wherein the pneumatic pump drains the fluid material from the photoresist tank through the buffer tank.

5. The piping system structure of semiconductor equipment of claim 2, wherein the fluid material comprises a photoresist.

6. The piping system structure of semiconductor equipment of claim 1, further comprising a buffer tank, which is disposed between the vessel and the pneumatic pump, wherein the pneumatic pump drains the fluid material from the vessel through the buffer tank.

7. The piping system structure of semiconductor equipment of claim 1, wherein the control module comprises a monitor unit to monitor whether the operation of the pneumatic pump is normal, and the monitor unit comprises:
at least two sensors, sensing a position of a valve of the pneumatic pump;
a programmable chip, coupled to the sensors to determine whether the operation of the pneumatic pump is normal according to the position of the valve of the pneumatic pump; and
a driving chip, controlling the monitor unit to monitor the pneumatic pump, when the operation of the pneumatic pump is abnormal, the driving chip generating a warning message.

8. The piping system structure of semiconductor equipment of claim 7, wherein the programmable chip is an 8051 chip.

9. The piping system structure of semiconductor equipment of claim 1, wherein the control module comprises:
a liquid adjusting valve, coupled to the pneumatic pump;
a flow control unit, controlling the pneumatic pump through the liquid adjusting valve to determine a time of stopping spraying the fluid material;
a gas adjusting valve, coupled to the pneumatic pump;
a magnetic valve, coupled to the liquid adjusting valve and the gas adjusting valve; and
a pressure control unit, driving the pneumatic pump through the magnetic valve.

10. The piping system structure of semiconductor equipment of claim 1, wherein the pneumatic pump comprises an IWAKI pump.

11. A piping system structure of semiconductor equipment, comprising:
a vessel, accommodating a fluid material;
a nozzle, spraying the fluid material over a wafer;
a pump, pumping the fluid material from the vessel to the nozzle to spray the fluid material over the wafer;
a first sensor, disposed at the pump to sense a first position of a valve in the pump and outputting a first sensing signal;
a second sensor, disposed at the pump to sense a second position of the valve in the pump and outputting a second sensing signal; and
a processor, receiving the first sensing signal and the second sensing signal, when a difference between a time of receiving the first sensing signal and a time of receiving the second sensing signal is larger than a preset value, the processor determining that an operation of the pump is abnormal and generating a warning message.

12. The piping system structure of semiconductor equipment of claim 11, wherein the semiconductor equipment is a photoresist coater.

13. The piping system structure of semiconductor equipment of claim 12, wherein the vessel comprises a photoresist tank.

14. The piping system structure of semiconductor equipment of claim 12, wherein the fluid material comprises a photoresist.

15. The piping system structure of semiconductor equipment of claim 12, further comprising a buffer tank, which is disposed between the photoresist tank and the pneumatic pump to remove bubbles in the fluid material.

16. The piping system structure of semiconductor equipment of claim 11, wherein the pump is a pneumatic pump.

17. The piping system structure of semiconductor equipment of claim 16, wherein the pneumatic pump comprises an IWAKI pump.

18. The piping system structure of semiconductor equipment of claim 16, wherein the control module comprises:
a liquid adjusting valve, coupled to the pneumatic pump;
a flow control unit, controlling the pneumatic pump through the liquid adjusting valve to determine a time of stopping spraying the fluid material;
a gas adjusting valve, coupled to the pneumatic pump;
a magnetic valve, coupled to the liquid adjusting valve and the gas adjusting valve; and
a pressure control unit, driving the pneumatic pump through the magnetic valve.

19. The piping system structure of semiconductor equipment of claim 11, wherein the first position is a lowest position of the valve in the pump, and the second position is a highest position of the valve in the pump.

20. The piping system structure of semiconductor equipment of claim 11, wherein the processor comprises a programmable chip.

21. The piping system structure of semiconductor equipment of claim 11, wherein the programmable chip is an 8051 chip.

22. The piping system structure of semiconductor equipment of claim 11, wherein the processor is coupled to a buzzer, and when the operation of the bump is abnormal, the processor triggers the buzzer to generating a warning sound.
